(19) United States
(12) Patent Application Publication
(10) Pub. No.: US 2004/0000018 A1
(43) Pub. Date: Jan. 1, 2004

(54) Handle reinforcement brace for attachment to a push broom

(76) Inventor: Christopher Choi, Los Angeles, CA (US)

Correspondence Address: Jerry H. Noh, Suite 2716, 3435 Wilshire Blvd, Los Angeles, CA, 90010, US

(21) Appl. No.: 10/185,653

(22) Filed: Jun. 28, 2002

(51) Int. Cl. A46B 15/00; B25G 3/00

(52) U.S. Cl. 15/175; 15/176.3; 16/440

(57) ABSTRACT

A brace for reinforcing the connection between a handle and head of a push broom. The brace comprising a flat elongated base member attached in a T-shaped configuration with an elongated tubular member. The base member being shaped to conform to the shape of the top side of the conventional push broom. A bore extending through the length of the tubular member and the base member for receiving a handle of a push broom therethrough. A plurality of apertures being formed through the base member and the tubular member.

### FIELD OF THE INVENTION

The present invention relates to a braces for push broom handles and more particularly a brace for reinforcing the attachment between a handle and head member of a push broom

### DESCRIPTION OF THE PRIOR ART

Push broom brushes typically comprise a handle member connecting to a head member. The head member further has a plurality of bristles protruding therefrom. With frequent use and especially in heavy industrial use, it is common for the handle to break at a portion near the connection to the head member. For a push broom where the handle member is permanently attached to the head member, the entire broom has to be discarded when the handle breaks. As such, push brooms commonly have a removable handle member with one end of the handle being threaded for engaging a threaded bore defined on the head member. A common inconvenience is that the handle can often become loose in use. Also with more frequent use, the tendency for the handle to become loose increases. Furthermore, frequent replacement of the handle can be expensive.

To address the inconvenience and problem, braces for push brooms have been developed. The braces include U.S. Pat. Nos. 2,922,179; 4,239,413; 5,568,668; and 5,337,440. The braces typically has a clamp portion attaching to the handle near the head member and a pair of brace rods connecting the clamp portion to the head member in a triangular pattern. None of the prior art teaches a brace as taught in the present invention.

### SUMMARY OF THE INVENTION

The present invention is contrived to overcome the conventional disadvantages. Accordingly, it is an object of the present invention to provide a brace for reinforcing the connection between the handle member and head member of a push broom. Furthermore it is an object of the present invention to prevent the loosening of the handle from the head member in use.

To achieve the above-described objects, the brace according to the present invention comprises a flat elongated base member and an elongated tubular member connecting to a central portion thereof in a T-shaped manner. The base member is essentially rectangular in shape to conform to the shape of the top side of the conventional push broom. The tubular member defines a bore extending through the length of the tubular member and through the base member. The bore is adapted to receive a handle of a push broom therethrough.

For securing the elongated member onto the top side of the head member of the push broom, a plurality of apertures are formed through the base member and the tubular member so that threaded fasteners can extend through the holes and into the push broom.

The base member and tubular member should be made of a durable rigid material for effective reinforcement.

Although the present invention is briefly summarized, the fuller understanding of the invention can be obtained by the following drawings, the detailed description and appended claims.

### BRIEF DESCRIPTION OF THE DRAWINGS

The present invention will be better understood with reference to the accompanying drawings, wherein:

FIG. 1 is a view of a common prior art brace shown attached to a push broom;

FIG. 2 is a side top perspective view of the present invention;

FIG. 3 is a front top perspective view of the present invention attached to a push broom;

FIG. 4 is an exploded perspective view of the present invention on a push broom; and,

FIG. 5 is a bottom view of the present invention.

### DETAILED DESCRIPTION OF THE PREFERRED EMBODIMENTS

With reference to the accompanying drawings, the preferred embodiments of the present invention will now be described.

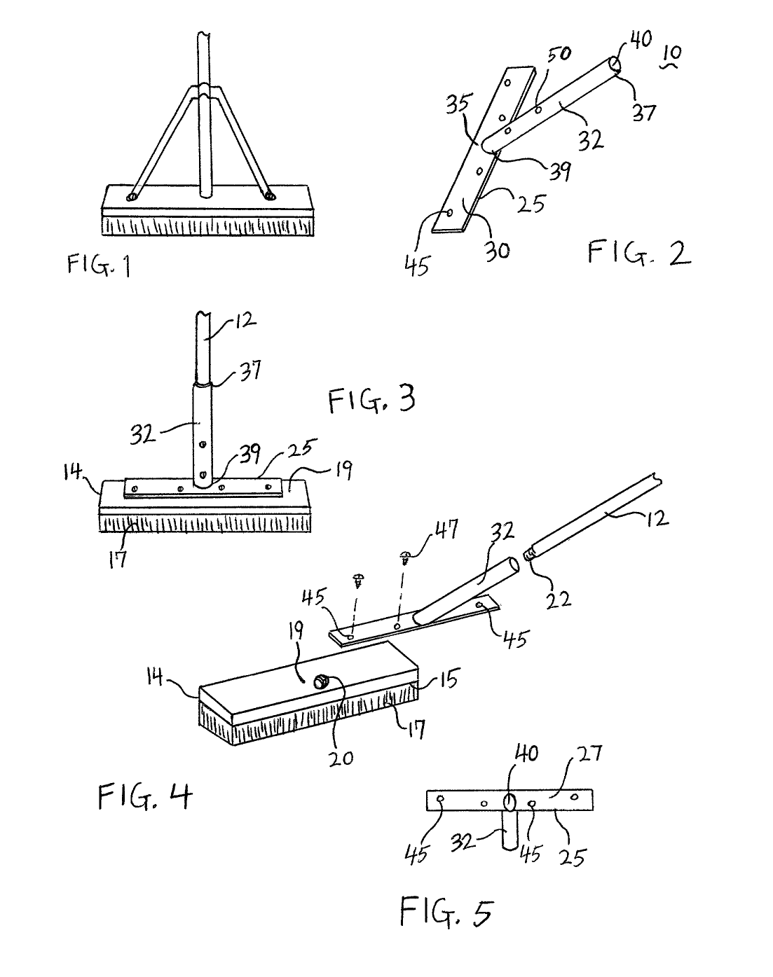

As best shown in FIGS. 2-5, the brace 10 for a push broom is illustrated. FIG. 1 shows a brace of the type taught in the prior art. The present invention, like that of the prior art is for use with a push broom 7 having a handle 12 and a head member 14 with the head member 14 having a bottom side 15 with a plurality of bristles 17 extending therefrom and a top side 19 having a threaded bore 20 extending thereinto. The handle 12 of the push broom 7 further has a threaded end 22 removably attaching to the head member 14 by screwing into the threaded bore 20. The brace 10 of the present invention improves the reinforcement of the connection between the handle 12 and the head member 14 and also improves in protecting the handle 12 from breaking near the head member 14.

The brace 10 of the present invention has a flat elongated base member 25 made of a rigid durable material having a bottom side 27 and a top side 30. As shown in the figures, the base member 25 can be rectangular in shape and of a predetermined size and shape conforming essentially to that of the top side 19 of the head member 14 of the push broom 7. An elongated tubular member 32 connects to the base member 25 at essentially a central portion 35 thereof. The tubular member 32 should also be made of a durable rigid material. The tubular member 32 has an upper edge 37 and a lower edge 39, and the lower edge 39 connects to the top side 30 of the base member 25. The tubular member 32 defines a bore 40 extending through the length of the tubular member 32 and through the base member 25. The bore 40 is adapted to a predetermined shape and size necessary to receive the handle 12 of the push broom 7 therethrough.

For securing the base member 25 onto the top side of the head member 14 of the push broom 7, a plurality of holes 45 are formed through the base member 25 so that threaded fasteners 47 can extend through the holes 45 and into the head member 14.

In use as illustrated in FIG. 2, a handle 12 of the push broom 7 is first removed from the head member 14, and the brace 10 of the base member 25 is placed against the head member 14 with the bore 40 of the brace 10 in alignment with the threaded bore 20 of the head member 14. Next, the threaded end 22 of the handle 12 is inserted into the bore 40 of the brace 10 and screwed into the threaded bore 20 of the push broom 7. Threaded fasteners 47 are inserted through the holes 45 on the base member 25 and into the head member 14 to secure the brace 10 onto the push broom 7.

The brace 10 of the present invention can further include one or more apertures 50 through the tubular member 32 for securing the brace 10 onto the handle 12 of the push broom 7 by use of a threaded fastener 47 passed through the aperture 50 and into the handle 12. With the brace 10 secured to the handle 12, this also prevents the handle 12 from twisting loose from the threaded bore 20.

In the embodiment of the present invention shown, the tubular member is perpendicular to the length of the base member. Furthermore, in the embodiment shown the threaded fasteners are threaded screws of the type known in the prior art.

Although the present invention has been described in considerable detail with reference to certain preferred versions thereof, other versions are possible by converting the aforementioned construction. Therefore, the scope of the invention shall not be limited by the specification specified above and the appended claims.

What is claimed is:

1. A brace for a push broom having an elongated handle and a head member, said head member having a bottom side with a plurality of bristles extending therefrom and a top side with a threaded bore extending thereinto, said handle having a threaded end removably attaching to said head member by engagement with said threaded bore, said brace comprising:
a flat elongated base member made of a rigid durable material having a bottom side and a top side;
an elongated tubular member having an upper edge and a lower edge, said lower edge of said tubular member connecting to said top side of said base member;
said tubular member defining a bore extending through said length of said tubular member and through said base member, said bore being adapted to receive a handle of a push broom therethrough; and,
a plurality of holes extending through said base member for securing said elongated member onto a top side of a head member of a push broom by use of threaded fasteners extending through said holes.

2. A brace as described in claim 1 further comprising one or more apertures extending through said tubular member for securing said brace onto a handle of a push broom by use of a threaded fastener through said aperture when said brace is placed on a push broom.

3. A brace as described in claim 1 wherein said tubular member is perpendicular to the length of the base member.

4. A brace for a push broom having a handle and a head member, said head member having a bottom side with a plurality of bristles extending therefrom and a top side with a threaded bore extending thereinto, said handle having a threaded end removably attaching to said head member by engagement with said threaded bore, said brace comprising:
an elongated tubular member having an upper edge and a lower edge, said tubular member defining a bore extending through said length of said tubular member, said bore being adapted to receive a handle of a push broom therethrough;
a flat elongated base member protruding sideward from the lower edge to define a portion protruding to the right of the lower edge and a portion protruding to the left of the lower edge;
a plurality of holes extending through said base member for securing said elongated member onto a top side of a head member of a push broom by use of threaded fasteners extending through said holes.

5. A brace as described in claim 4 further comprising one or more apertures extending through said tubular member for securing said brace onto a handle of a push broom by use of a threaded fastener through said aperture when said brace is placed on a push broom.

6. A brace as described in claim 4 wherein said tubular member is perpendicular to the length of the base member.

7. A brace as described in claim 4 wherein said tubular member and base member are made of a durable rigid material.
